(19) United States
(12) Patent Application Publication
(10) Pub. No.: US 2014/0239068 A1
(43) Pub. Date: Aug. 28, 2014

(54) CREDIT CARD WITH ALTERABLE ID/SECURITY FEATURES

(71) Applicant: John Chowhan Park, Washington, DC (US)

(72) Inventor: John Chowhan Park, Washington, DC (US)

(21) Appl. No.: 13/774,276

(22) Filed: Feb. 22, 2013

(51) Int. Cl. G06K 19/06; G06K 7/01

(52) U.S. Cl. CPC G06K 19/06196; G06K 7/01
USPC 235/449; 235/493

(57) ABSTRACT

This invention relates to a card with alterable security features are displayed and method of enhancing security of a financial transaction card. The present invention provides a financial transaction card with alterable ID/Security features including an E-paper display unit on one or both surfaces of the card that displays alterable ID/Security features. The alterable ID/Security features include account numbers, names, security codes, dates, phone numbers, addresses, photos, and computer-readable codes. The alterable ID/Security features can be edited, changed, erased, or replaced.

### FIELD OF INVENTION

This invention relates to a card with alterable security features that are displayed, and method of enhancing security of a financial transaction card.

### DESCRIPTION OF PRIOR ART

The credit card is essential instrument of modern commerce. Since more people are using the credit card more security features to protect personal/financial information has developed. Currently, most of credit cards are made of piece of plastic on which magnetic stripe is embedded. Credit card numbers, names, expiration dates, security codes are imprinted or fixed on surface of the credit card. This credit card numbers or date of expiration could not be changed since the numbers were fixed on the surface of the card. In order to assign new credit card number or expiration date, the card issuer has to issue new card with new numbers or date printed on the card.

The combination of a card and electronic paper (“E-paper”) were developed. Such combination features a credit card with E-paper display which displays additional security code for enhancing security code but does not alter or change information printed or fixed on the card.

### SUMMARY OF THE INVENTION

According to various feature, characteristics and embodiments of the present invention which will become apparent as the description thereof proceeds, the present invention provides a financial transaction card with alterable ID/Security features comprising: a card for financial transaction, E-paper display unit on one or both surfaces of the card, wherein the E-paper display unit displays alterable ID/Security features. The alterable ID/Security features comprise card numbers, names, security codes, dates, phone numbers, addresses, photos, and computer-readable codes. The alterable ID/Security features can be edited, changed, erased, or replaced.

A card reader can be coupled with the financial transaction card. The card reader transmits and receives data to/from the financial transaction card with alterable ID/Security features. The card reader can edit, change, erase, or replace the alterable ID/Security features appear on the E-paper display unit.

In one implementation, the financial transaction card may include a magnetic stripe capable of storing data. The card reader can edit, change, erase, or replace data stored in the magnetic stripe.

In another implementation, the financial transaction card may include a computer-readable storage unit, a power supply unit, and a processor which controls operation of the E-paper display unit.

In yet another implementation, the financial transaction card and the card reader can communicate via electrical signal, radio signal or optical signal. The financial transaction card may have electrodes with which electrical data is transmitted/received.

The present invention provides method of enhancing security with the financial transaction card comprising: couple a card reader and a financial transaction card; edit, change, erase, or replace ID/Security features appears on an E-paper display unit; and edit, change, erase, or replace data stored in magnetic stripe. The alterable ID/Security features and data stored in the magnetic stripe can be changed each time the financial transaction card and the card reader couples.

In one implementation, portion of the alterable ID/Security features and data stored in the magnetic stripe can be changed when the financial transaction card and the card reader couples.

In another implementation, all ID/Security features appear on an E-paper display unit may be erased or replaced with warning sign or alert.

### BRIEF DESCRIPTION OF THE DRAWINGS

The above and other objects, features and advantages of the present invention will be more clearly understood from the following detailed description taken in conjunction with the accompanying drawings, in which:

FIG. 1a is a front view of exemplary embodiment of the financial transaction card with E-paper display unit implanted on the surface of the card.

FIG. 1b is a rear view of exemplary embodiment of the financial transaction card with E-paper display unit implanted on the surface of the card.

FIG. 1c is a cross-sectional view of exemplary embodiment of the financial transaction card with E-paper display unit implanted on the surface of the card.

FIG. 2a is a perspective view of exemplary embodiment of the financial transaction card with electrodes which is implanted on the financial transaction card.

FIG. 2b is a perspective view of exemplary embodiment of the financial transaction card with electrodes which is implanted on the E-paper display unit.

FIG. 2c is a cross-sectional view of exemplary embodiment of the financial transaction card with electrodes which is implanted on the financial transaction card

FIG. 3a is a perspective view of exemplary embodiment illustrating exemplarily that the credit card number may be edited or changed.

FIG. 3b is a perspective view of exemplary embodiment illustrating exemplarily that the expiration date may be edited or changed.

FIG. 4 is a perspective view of exemplary embodiment illustrating exemplarily that the credit card displaying alert or warning message.

### DETAILED DESCRIPTION OF THE INVENTION

References will now be made in detail to a few embodiments of the invention, examples of which are illustrated in the accompanying drawings. While the invention will be described in conjunction with the particular embodiments, it will be understood that it is not intended to limit the invention to the described embodiments. To the contrary, it is intended to cover alternatives, modifications, and equivalents as may be included within the spirit and scope of invention as defined by the appended claims. The present disclosure uses a financial transaction card with an e-paper display as an exemplary case to illustrate the inventive concept. The inventive concept may be applied to any other computer readable cards and to any other types of displays, which do not consume electrical power when the displayed message or image is not altered.

The E-paper is a type of reflective display technology and can provide as high resolution as ordinary ink on paper, wide viewing angles, and excellent visual properties. E-paper can be implemented on various types of substrates such as a plastic, metallic or paper substrate and can display and maintain an image thereon even after power is cut off. So, E-paper can hold text or image without consuming electrical power when content is not altered. The E-paper display unit may be implemented as e-paper by using electrostatic-charged hemispherical twist balls, using electrophoretic deposition, using microcapsules, using electrowetting, using electrofluidic, using electrochromic, and/or using IMOD.

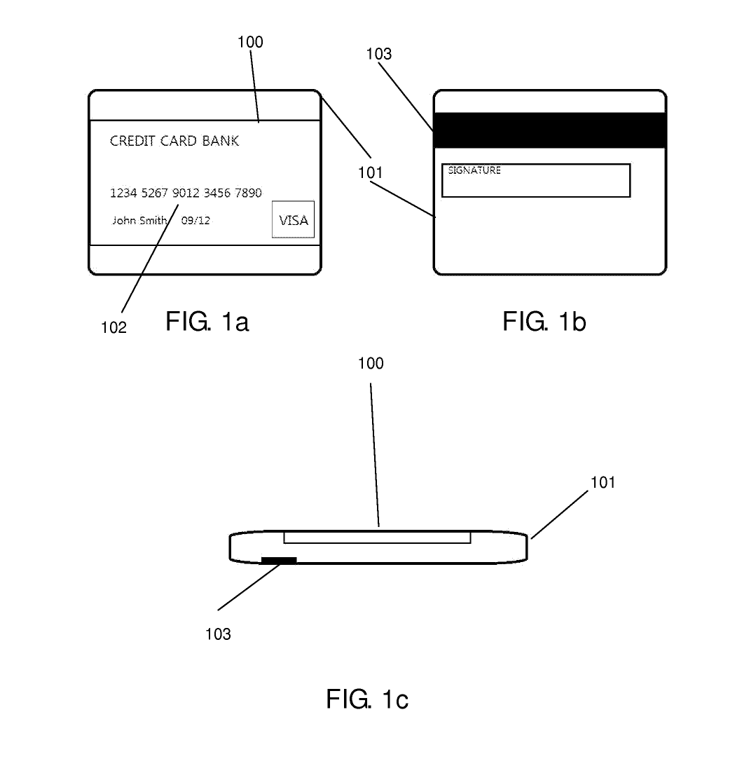

FIG. 1a, FIG. 1b, and FIG. 1c perspective views of exemplary embodiment of the financial transaction card with E-paper display unit implanted on the surface of the card. The E-paper display unit 100 may be implanted on one surface of the card 101 as well as both surfaces of the card 101. The E-paper display unit 100 is reflective and no electrical power is consumed if the text or the images are not altered. . Alterable ID/Security features 102 are displayed on the E-paper display unit 100. The alterable ID/Security features 102 comprise card numbers, names, security codes, dates, phone number, addresses, images, and computer-readable codes. The alterable ID/Security features 102 may be edited, changed, erased, or replaced when the card is coupled with the card reader. The alterable ID/Security features 102 may be edited, changed, erased, or replaced by itself without coupling with the card reader. The card may have the magnetic stripe in which data can be stored.

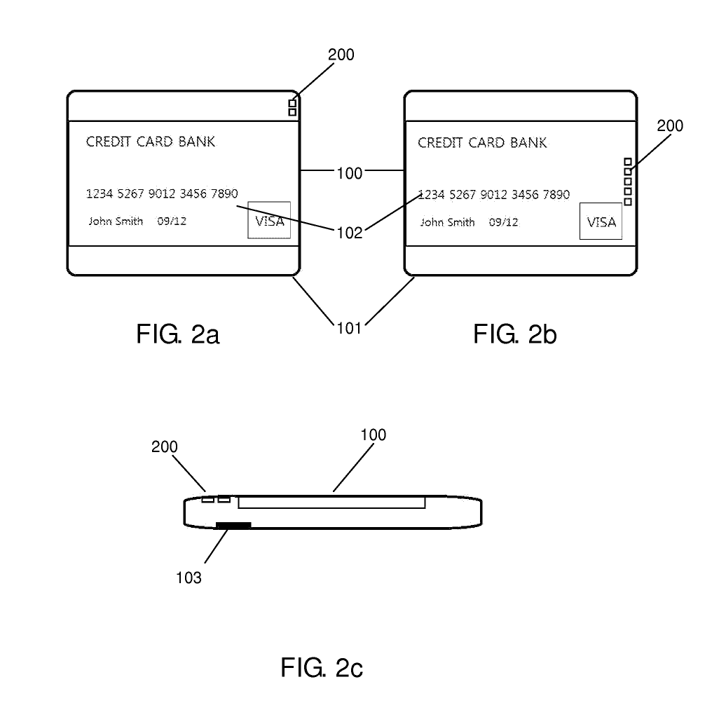

FIG. 2a, FIG. 2b, and FIG. 2c are perspective views of exemplary embodiment of the financial transaction card 101 with electrodes 200 which is implanted on the financial transaction card. The electrodes 200 can be implanted on any surface of the card 101 or can be implanted on the surface of E-paper display unit 100. A card reader can communicate with the financial transaction card 101 electronically via electrodes 200.

Power is transferred from the card reader to the financial transaction unit upon coupling of the card reader and the financial transaction card 101. Power can be transferred through electrodes 200 imbedded on the card 101 or E-paper display unit 100.

The financial transaction card 101 may include a power supply unit imbedded on the card. The power supply unit may be battery or solar power panel. The power supply unit supplies power to the E-paper display unit 100 to alter the ID/Security features 102 on the E-paper display unit 100. Data storage unit may be included in the financial transaction card 101. Data storage unit stores ID/Security data. The data in data storage unit can be accessed by E-paper display unit 100. The data in the data storage unit can be transmitted and received from the card reader when the card 101 and the card reader are connected. The financial transaction card 101 may include processor that controls operation of E-paper display unit 100.

When the card reader is coupled with the card 101, the card reader communicate with the card to edit, change, erase, or replace the alterable ID/security features 102 displayed on the E-paper display unit 100. The communication between the card reader and the card 101 can be carried out via electronically through electrodes 200 or the communication can be carried out via radio signal or optical signal. The card reader can read data from the magnetic stripe 103. The card reader may also edit, changed, erased, or replaced data stored in the magnetic stripe 103.

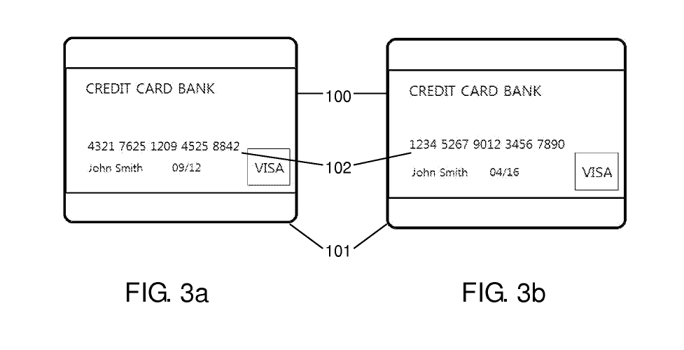

FIG. 3a and FIG. 3b are perspective views of two exemplary embodiments illustrating exemplarily that the alterable ID/Security features may be edited or changed. FIG. 2a illustrates that new card number can be assigned to the financial transaction card through changing or editing the alterable ID/Security features 102 displayed on E-paper display unit 100 on the financial transaction card 101. FIG. 2b illustrates that new expiration date can be assigned to financial transaction through changing or editing the alterable ID/Security features 102 displayed on E-paper display unit 100 on the financial transaction card 101. When the alterable ID/Security features 102 are edited, changed, erased, or replaced, data stored in the magnetic stripe 103 may be edited, changed, erased, or replaced simultaneously to conform with the change to the alterable ID/Security features 102 or vice versa.

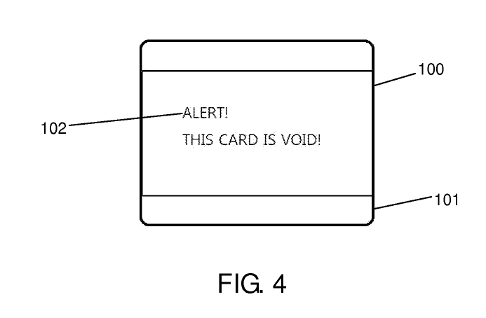

FIG. 4 is a perspective view of exemplary embodiment illustrating exemplarily that the credit card 101 displaying alert or warning message 400. When the card issuers detect fraud or identity theft, the card issuers can order to suspend or cancel the financial transaction card. In this case, the card reader may transmit data to instruct E-paper display unit 100 to display alert or warning message 400 when the financial transaction card 101 couples with the card reader or ATM. Additionally, the financial transaction card may display alert or warning message 400 by itself without coupling with the reader. The processor imbedded in the financial transaction card 101 can count the date and instruct E-paper display unit 100 to display alert or warning message 400 upon expiration of the credit card.

1. A financial transaction card with alterable ID/Security features comprising:
an E-paper display unit on at least one surfaces of the card,
wherein the E-paper display unit displays alterable ID/Security features
wherein the alterable ID/Security features comprise account numbers, names, dates, phone numbers, addresses, and computer-readable codes.

2. The financial transaction card with alterable ID/Security features recited in claim 1,
wherein the alterable ID/Security features can be edited, changed, erased, or replaced.

3. (canceled)

4. The financial transaction card with alterable ID/Security features recited in claim 1 further comprising:
a card reader which transmits and receives data to/from the financial transaction card with alterable ID/Security features,
wherein the card reader edits, changes, erases, or replaces the alterable ID/Security features appears on the E-paper display unit.

5. The financial transaction card with alterable ID/Security features recited in claim 1, further comprising:
a magnetic stripe that stores data.

6. The financial transaction card with alterable ID/Security features recited in claim 5,
wherein the card reader edits, changes, erases, or replaces data stored in the magnetic stripe.

7. The financial transaction card with alterable ID/Security features recited in claim 1, further comprising:
a computer-readable storage unit that stores data.

8. The financial transaction card with alterable ID/Security features recited in claim 1, further comprising:
a power supply unit that supplies power to E-paper display unit.

9. The financial transaction card with alterable ID/Security features recited in claim 1, further comprising:
a processor that controls operation of E-paper display unit.

10. The financial transaction card with alterable ID/Security features recited in claim 4,
wherein the card reader transmits and receives data from the E-paper display unit of the financial transaction card with alterable ID/Security Features via electrical signal.

11. The financial transaction card with alterable ID/Security features recited in claim 4,
wherein the card reader transmits and receives data from the E-paper display unit of the financial transaction card with alterable ID/Security Features via radio signal or optical signal.

12. Method of enhancing security with the financial transaction card with alterable ID/security features comprising:
coupling a card reader and a financial transaction card,
editing, changing, erasing, or replacing alterable ID/Security features appears on an E-paper display unit,
editing, changing, erasing, or replacing data stored in magnetic stripe.

13. The method of enhancing security with the financial transaction card with alterable ID/security features recited in claim 12,
wherein alterable ID/Security features and data stored in the magnetic stripe are changed each time the financial transaction card and the card reader are connected.

14. The method of enhancing security with the financial transaction card with alterable ID/security features recited in claim 12,
wherein a portion of alterable ID/Security features and data stored in the magnetic stripe are changed when the financial transaction card and the card reader are connected.

15. The method of enhancing security with the financial transaction card with alterable ID/security features recited in claim 12,
wherein all alterable ID/Security features appears on an E-paper display unit are erased or replaced with alert or warning message.

16. The method of enhancing security with the financial transaction card with alterable ID/security features recited in claim 15,
wherein all alterable ID/Security features appears on an E-paper display unit are erased or replaced with alert or warning message upon expiration of the financial transaction card.
